(19) United States
(12) Patent Application Publication
(10) Pub. No.: US 2026/0292403 A1
(43) Pub. Date: Sep. 24, 2026

(54) AUDIO DOCK FOR SEAMLESS TRANSITION BETWEEN AUDIO STREAMS

(71) Applicant: Hewlett-Packard Development Company, L.P., Spring, TX (US)

(72) Inventors: Hytham Alihassan, Austin, TX (US); Mehdi Ashari, Morgan Hill, CA (US)

(21) Appl. No.: 19/168,568

(22) PCT Filed: Mar. 27, 2023
(86) PCT No.: PCT/US2023/065001

§ 371 Date: Sep. 24, 2025

(51) Int. Cl. H04R 5/04; H04R 3/00; H04R 5/033

(52) U.S. Cl. CPC H04R 5/04; H04R 3/005; H04R 5/033; H04R 2420/07

(57) ABSTRACT

Systems and methods are provided for an audio dock to seamlessly transition between audio signals. The audio dock can receive a first audio signal (505) being indicative of captured audio and having a first latency and a second audio signal (510) being indicative of the captured audio and having a second latency that is lower than the first latency. The audio dock can determine a time delay (525) between the first audio signal and a second audio signal and introduce the time delay (540) to the second audio signal to provide a delayed audio signal (545). The audio dock can select, (550) based on a control signal (252), the first audio signal or the delayed audio signal as an output audio signal (280). The audio dock can output the output audio signal to a host device.

### BACKGROUND

An audio device may be used to capture audio, via a microphone, to produce audio signals for a host device and to output audio, via a speaker, corresponding to an audio signal received from the host device. Audio devices are provided in various forms including, for example, wired headsets, wireless headsets, speakerphones, earbuds, and the like. An audio dock may serve as an interface between a host device and one or more audio devices.

The discussion above is merely provided for general background information and is not intended to be used as an aid in determining the scope of the claimed subject matter.

### BRIEF DESCRIPTION OF THE DRAWINGS

The following drawings are provided to help illustrate various features of non-limiting examples of the disclosure and are not intended to limit the scope of the disclosure or exclude alternative implementations.

FIG. 1 schematically illustrates a system for implementing audio communication with one or more audio devices according to some examples.

FIG. 2A schematically illustrates a system for implementing audio communication with two audio devices according to some examples.

FIG. 2B schematically illustrates a system for implementing audio communication with an audio device including both wireless and wired interfaces according to some examples.

FIG. 3 schematically illustrates communication circuitry of an audio device according to some examples.

FIG. 4 illustrates a method for implementing seamless audio transition between audio signals according to some examples.

FIG. 5A illustrates a functional diagram for an audio dock according to some examples.

FIG. 5B illustrates plots of buffered high and low latency audio signals according to some examples.

FIGS. 6A-6F illustrate an audio dock in communication with various audio devices and receiving various audio signals according to some examples.

### DETAILED DESCRIPTION OF THE PRESENT DISCLOSURE

The disclosed technology is not limited in its application to the details of construction and the arrangement of components set forth in the following description or illustrated in the following drawings. Other examples of the disclosed technology are possible and examples described and/or illustrated here are capable of being practiced or of being carried out in various ways.

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computing device or can be distributed among different computing devices connected by one or more networks or other suitable communication links.

As described above, an audio device may be used to capture audio, via a microphone, to produce audio signals for a host device, and to output audio, via a speaker, corresponding to an audio signal received from the host device. Accordingly, an audio dock may serve as an interface between a host device (e.g., a laptop computer, desktop computer, smart phone, or electronic tablet, or the like) and one or more audio devices (e.g., wired headsets, wireless headsets, combined wired/wireless headsets, speakerphones, earbuds, or the like). When an audio dock switches between incoming audio signals from one or more audio devices, a delay, undesired noise (e.g., echo, pop, etc.), or momentary interruption may occur in the audio signal that the audio dock provides to the host device (from the audio device) in the audio signal. Similarly, when an audio dock switches the audio signal that the audio dock outputs to the one or more audio devices, a delay, noise, or momentary interruption may occur in the audio output to a user. When the audio device(s) is/are being used to capture a user's voice as audio for use in a teleconference, another participant or participants in the conference may hear the delay, noise, or momentary interruption on their respective audio devices or speakers. Further, no industry standard or specification defines a technique for a seamless transition between audio devices.

Accordingly, in some examples, the technology disclosed herein can provide a seamless transition between audio signals is provided to remove or reduce one or more of the delay, noise, and interruption. By providing the seamless transition, the communication between participants in the teleconference may be clearer and a user may switch audio devices or switch modes of a single audio (e.g., between wired and wireless or between wireless and wired) without other participants in the teleconference being able to detect or notice the switch.

In some examples, the technology disclosed herein provides a method. The method can include receiving, by an electronic processor, a first audio signal being indicative of captured audio and having a first latency. The method can include receiving, by the electronic processor, a second audio signal being indicative of the captured audio and having a second latency that is lower than the first latency. The method can include determining, by the electronic processor, a time delay between the first audio signal and a second audio signal. The method can include introducing, by the electronic processor, the time delay to the second audio signal to provide a delayed audio signal. The method can include selecting, by the electronic processor, based on a control signal, the first audio signal or the delayed audio signal as an output audio signal. The method can include outputting, by the electronic processor, the output audio signal to a host device.

In some examples, technology disclosed herein provides an apparatus, more specifically, an audio dock. The audio dock can include a communication interface including a first transceiver, a second transceiver, and a third transceiver. The first transceiver to receive a first audio signal indicative of captured audio and having a first latency, the second transceiver to receive a second audio signal indicative of the captured audio and having a second latency that is lower than the first latency, and the third transceiver providing a communication link to a host device. The audio dock can include an audio processing circuit coupled to the communication interface. The audio processing circuit can determine a time delay between the first audio signal and a second audio signal. The audio processing circuit can introduce the time delay to the second audio signal to provide a delayed audio signal. The audio processing circuit can select, based on a control signal, the first audio signal or the delayed audio signal as an output audio signal. The audio processing circuit can output the output audio signal to the host device via the third transceiver.

In some examples, the technology disclosed herein provides a non-transitory computer-readable medium storing instructions that, when executed by an electronic processor, perform a set of functions. The set of functions can include receiving a first audio signal from a first audio device that is indicative of captured audio and having a first latency. The set of functions can include receiving a second audio signal from a second audio device that is indicative of the captured audio and having a second latency that is lower than the first latency. The set of functions can include determining a time delay between the first audio signal and a second audio signal. The set of functions can include introducing the time delay to the second audio signal to provide a delayed audio signal. The set of functions can include selecting based on a control signal, the first audio signal or the delayed audio signal as an output audio signal. The set of functions can include outputting the output audio signal to a host device.

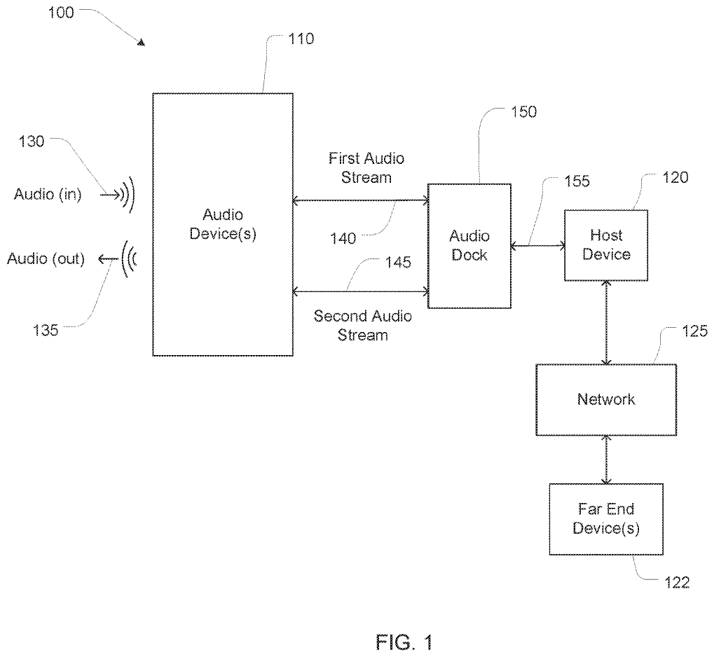

FIG. 1 illustrates a system 100 for implementing audio communication with one or more audio devices. In the illustrated example, the system 100 includes one or more audio devices 110, a host computing device 120 (herein host device 120) that is connected to a far end computing device 122 (herein far end device 122) through a network 125. The connections between the host device 120 and the far end device 122 via the network 125 can include one or both of wired or wireless communication links. For example, the network 125 may include a wide area network (e.g., the Internet or a cellular network), a local area network (e.g., Wi-Fi or Bluetooth), or combinations or derivatives thereof. In some examples, the far end device 122 can include additional, or different far end devices than illustrated in FIG. 1. In some examples, the host devices 120 can be associated with a first user and the far end device 122 can be associated with a second user. In some examples, the far end device 122 can be associated with multiple users simultaneously or may include multiple far end devices 122 each associated with a respective far end user or users.

The host device 120 can include, for example, a desktop computer, a laptop computer, a tablet computer, a terminal, a smart telephone, a smart television, or another suitable computing device that interfaces with a user. Similarly, the far end device 122 can include, for example, a desktop computer, a laptop computer, a tablet computer, a terminal, a smart telephone, a smart television, or another suitable computing device that interfaces with a far end user. As described in greater detail herein, the host device 120 and the far end device 122 can be used by respective users for interacting with a communication platform (e.g., as participants in a teleconference).

In some examples, a memory (not shown) of the host device can include at least one communication application. The communication application may be a software application executable by an electronic processor (not shown) of the host device and that is associated with at least one communication platform (e.g., an electronic communication platform). For example, a user can access and interact with the associated communication platform via the communication application. In some examples, the memory includes multiple communication applications, each communication application associated with a different communication platform. The electronic processor can execute the communication application to enable user interaction with a communication platform (e.g., a communication platform associated with the communication application). The communication application can be a web-browser application that enables access and interaction with a communication platform, such as, e.g., a communication platform hosted by a remote server (e.g., where the communication platform is a web-based service). Alternatively, or in addition, the communication application can be a dedicated software application that enables access and interaction with a communication platform. Accordingly, in some examples, the communication application can function as a software application that enables access to a communication platform or service. In some examples, the far end device 122 similarly includes a memory storing at least one communication application and an electronic processor for executing the communication application to enable access to a communication platform by a far end user.

The audio device(s) 110, also referred to as audio input/output (I/O) device(s) 110, receive an audio input 130 and generate an audio output 135. The audio device(s) 110 may be, for example, one or more of a wired headset, a wireless headset, a wired speakerphone, a wireless speakerphone, a combined wired/wireless headset, a combined wired/wireless speakerphone, one wireless earbud audio device, or a pair of wireless stereo earbud audio devices. A headset generally includes a head support (e.g., strap, arched band to sit on top of the user's head, etc.) configured to secure the headset to the user's head and to support a microphone. In some cases, the microphone of a headset may be positioned on an arm of the headset extending away from the head support and toward the user's mouth.

Wireless stereo earbud audio devices may include a left earbud and a right earbud, each configured to fit, in part, within a respective left and right ear canal of the user. Each wireless earbud may be considered a respective audio device of the audio device(s) 110. When both wireless earbuds are in active operation, a first earbud may be considered a primary earbud, while a second earbud may be considered a secondary earbud. The primary earbud may establish a primary wireless link (e.g., a Bluetooth or Wi-Fi link) with the audio dock 150 (e.g., the first audio stream 140) with two channels, a first channel for the first earbud and a second channel for the second earbud. The primary earbud may transmit and receive audio data for the primary (first) earbud (e.g., audio captured via a microphone of the primary earbud and audio for output via a speaker of the primary earbud) using the first channel. The primary earbud may also receive and transmit audio data of the second channel (e.g., audio captured via a microphone of the secondary earbud and audio for output via a speaker of the secondary earbud) wirelessly between the secondary earbud (via an inter-earbud wireless communication link) and the audio dock 150 (via the wireless communication link). In some examples, the secondary earbud may further establish an out-of-band wireless link (e.g., a Bluetooth Low Energy (BLE) link or Wi-Fi link) with the audio dock 150 (e.g., the second audio stream 145). When the communication link between the audio dock 150 and the primary earbud is interrupted, the secondary earbud may become the primary earbud and the formerly primary earbud (when available) may become the secondary earbud. In this case, the (new) primary earbud may use the previous out-of-band wireless link as the primary wireless link

A combined wired/wireless headset refers to a headset configured to connect to the audio dock 150 via a wired connection (e.g., via an ⅛ in. or ¼ in. audio plug) and also via a wireless connection (e.g., via Bluetooth or Wi-Fi link) for example, based on user preference and selection in a particular scenario. Similarly, a combined wired/wireless speakerphone refers to a speakerphone configured to connect to the audio dock 150 via a wired connection and also via a wireless connection for example, based on user preference and selection in a particular scenario.

The audio input 130 represents audio or sound received by the audio device(s) 110 generated by one or more audio sources proximate to the audio device(s) 110. For example, the audio input 130 may include one or more of a user's voice, multiple users' voices (e.g., co-located in a room or area), ambient environment noise within audible range of audio device(s) 110, and the like. The audio output 135 represents audio or sound output by one or more speakers of the audio device(s) 110.

The audio device(s) 110 further communicate with the audio dock 150 via one or more audio streams. For example, the one or more audio streams may include a first audio stream 140 and a second audio stream 145. In some examples, additional audio streams are provided in addition to the first and second audio streams 140, 145. The one or more audio streams, including streams 140 and 145, may be unidirectional streams to the audio dock 150, unidirectional streams from the audio dock 150, bidirectional streams to and from the audio dock 150, or a combination thereof. The audio dock 150 further communicates with the host device 120 via host audio stream 155. The host audio stream 155 may be a unidirectional stream to the host device 120, unidirectional streams from the host device 120, or a bidirectional stream.

The audio dock 150 may serve as an audio interface between the audio device(s) 110 and the host device 120. As discussed in further detail below, the audio dock 150 may seamlessly transition between the one or more audio streams (e.g., the streams 140 and 145) and link the selected one of the audio streams with the host device 120.

In some examples, the audio dock 150 receives power from the host device 120. For example, the audio dock 150 may be coupled to the host device 120 via a wired connection that provides both a data ink and a power link (e.g., a USB 2.0 connection, USB 3.0 connection, or the link) or may have a wireless power connection to the host device 120 for inductive power transfer. In some examples, the audio dock 150 may similarly provide power to one or more of the audio device(s) 110 via a wired or wireless connection to the one or more audio device(s) 110.

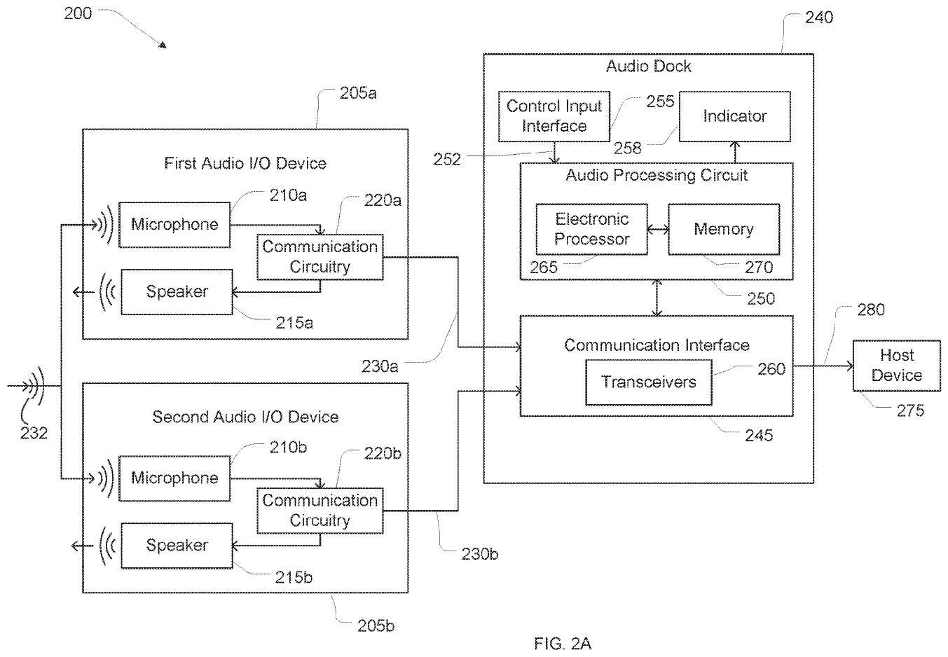

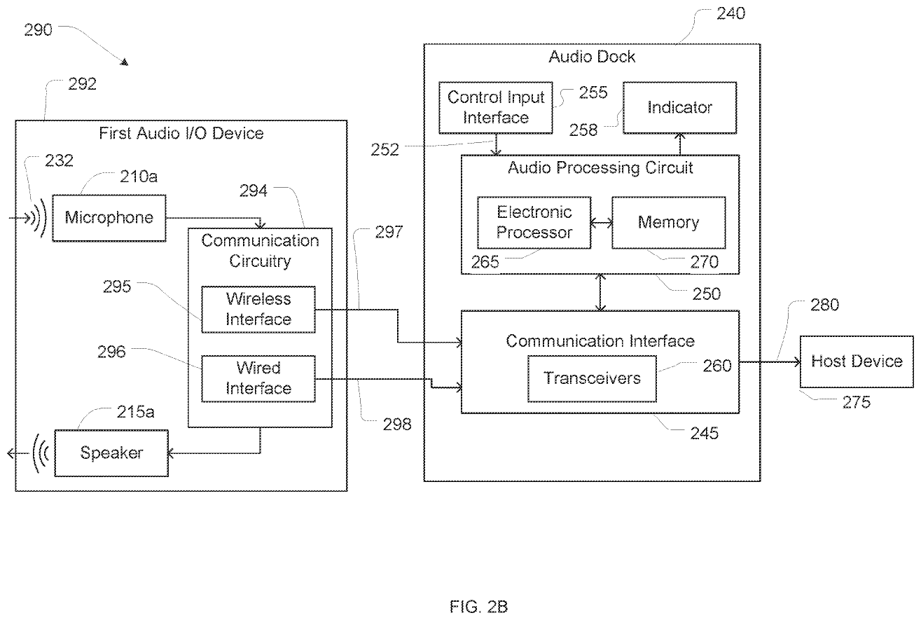

FIG. 2A illustrates a system 200 for implementing audio communication with two audio devices, according to some examples. The system 200 includes a first audio device 205a and a second audio device 205b, an audio dock 240, and a host device 275. The system 200 of FIG. 2A can be an example of a portion of the system 100 of FIG. 1. For example, the first audio device 205a and the second audio device 205b are examples of two audio devices of the audio device(s) 110; the audio dock 240 is an example of the audio dock 150, and the host device 275 is an example of the host device 120. Accordingly, the discussion of the components in FIG. 1 is similarly applicable to the corresponding examples of these components in FIG. 2A, unless otherwise noted.

The first audio device 205a includes a microphone 210a (e.g., to receive and capture audio input), a speaker 215a (e.g., to generate audio output), and communication circuitry 220a. Similarly, the second audio device 205b includes a microphone 210b (e.g., to receive and capture audio input), a speaker 215b (e.g., to generate audio output), and communication circuitry 220b. However, in some examples, the system 200 can include fewer, additional, or different components in different configurations than illustrated in FIG. 2A. For example, one or both of the audio devices 205a, 205b may include multiple microphones or multiple speakers. As another example, one or both of the audio devices 205a, 205b may include a power source (e.g., a battery) to power components thereof, for example, the communication circuitry 220a, 220b. In other examples, one or both of the audio devices 205a, 205b may not include a power source and, instead, may be passive devices (e.g., without active signal processing components or amplification) or may receive power from a wired or wireless connection with the audio dock 240 to power components thereof. As another example, one or more components of the system 200 can be combined into a single device, divided among multiple devices, or a combination thereof.

The first and second microphones 210a, 210b of the first and second audio devices 205a, 205b capture an audio input 232. The audio input 232 is an example of the audio input 130 of FIG. 1 and may include, for example, a user's voice, users' voices, ambient noise, other sound generated near the microphones 210a and 210b, and the like. In this illustration, the microphones 210a and 210b capture substantially the same audio input 232. For example, because the audio devices 205a and 205b are located proximate to one another, the microphones 210a and 210b are detecting audio or sound generated by the same audio source(s) (e.g., the same words spoken by the user are captured by both the first microphone 210a and by the second microphone 210b). Accordingly, the audio input 232 captured by the first audio device 205a and by the second audio device 205b may both be referred to as the captured audio.

The first microphone 210a transmits the captured audio to communication circuitry 220a and the second microphone 210b transmits the captured audio to communication circuitry 220b. The communication circuitry 220a transmits the captured audio as a first audio signal 230a and the communication circuitry 220b transmits the captured audio as a second audio signal 230b to the audio dock 240. The first audio signal 230a is an example of a first audio stream 140 (FIG. 1) and the second audio signal 230b is an example of a second audio signal 145 (FIG. 1). In some examples, the communication circuitry 220a may include one or more of analog conditioning circuitry (e.g., one or more analog filters, amplifiers, or the like) and digital processing circuitry. Digital processing circuitry may include an analog to digital (A/D) converter to convert the captured audio from an analog signal to a digital signal and one or more electronic processors to process the digital signal. The processing may include, for example, one or more of buffering, conditioning (e.g., filtering, amplifying, etc.) the digital signal. In some examples, the communication circuitry 220a includes both analog conditioning circuitry and digital processing circuitry. For example, in the case of the first audio device 205 implemented as a combined wired/wireless headset, the communication circuitry 220 may include and use the analog conditioning circuitry when communicating with the audio dock 240 via a wired link and use the digital processing circuitry when communicating with the audio dock 240 via a wireless link.

The communication circuitry 220a further includes communication interface components. The communication interface components may include a wireless interface, a wired interface, or both a wireless interface and a wired interface. A wired interface may include a physical connector or port to which a cable including one or more wires may be coupled. The connector may include an audio jack (e.g., a ¼ inch jack or ⅛ inch jack) or other port (e.g., USB port, Lightning port, or the like) to selectively receive a first plug end of the cable or an end of the cable may be permanently affixed or joined with the connector (e.g., by soldering or otherwise attaching wires of the cable to terminals of the connector). A wireless interface includes a wireless transceiver, which may include an antenna used by digital processing circuitry of the communication circuitry 220 to transmit and receive wireless signals (e.g., with the audio dock 240).

The description of the communication circuitry 220a, including the various components, examples, and variations thereof, similarly applies to the communication circuitry 220b in the context of the second audio device 205b. In some examples, the communication circuitry 220b has substantially the same configuration as the communication circuitry 220a, for example, when the first audio device 205a is a wireless headset and the second audio device 205b is a wireless earbud or speakerphone, or when the first audio device 205a is a left audio earbud and the second audio device 205b is a right audio earbud. In other examples, the communication circuitry 220a and the communication circuitry 220b have different configurations, for example, when the first audio device 205a a wireless headset and the second audio device 205b is a wired speakerphone.

The audio dock 240 includes a communication interface 245, an audio processing circuit 250, a control input interface 255, and an indicator 258. The first audio signal 230a and the second audio signal 230b can be received by the communication interface through the respective communication circuitries 220a, 220b of the first and second audio devices 205a, 205b. More particularly, the communication interface 245 may include one or more wireless interfaces, one or more wired interfaces, or both one or more a wireless interfaces and one or more wired interfaces. A wired interface may include a wired transceiver (of transceivers 260) and a physical connector or port to which a cable including one or more wires may be coupled. The connector may include an audio jack (e.g., a ¼ inch jack or ⅛ inch jack) or other port (e.g., USB port, Lightning port, or the like) to selectively receive a plug end of the cable or an end of the cable may be permanently affixed or joined with the connector (e.g., by soldering or otherwise attaching wires of the cable to terminals of the connector). A wired transceiver may include, for example, analog conditioning circuitry (e.g., one or more analog filters, amplifiers, or the like), an analog-to-digital converters, a digital-to-analog converters, driving circuitry, or the like. A wireless interface includes a wireless transceiver (of the transceivers 260), which may include an antenna used by the audio processing circuit 250 to transmit and receive signals wirelessly (e.g., with the audio device 205a, the audio deice 205b, and/or the host device 275. In some examples, portions of the transceivers 260 are shared (e.g., through time multiplexing, frequency multiplexing, etc.). For example, the transceivers 260 may include multiple transceivers that share an antenna for wireless transmission. In other examples, the transceivers 260 may include multiple transceivers that each have a respective antenna (or antennas) for wireless transmission. In some examples, the number of transceivers 260 can be fewer, same, or more than the number of audio signals transmitted to the audio dock 240 and host device 275.

In the illustrated example, the communication interface 245 receives and transmits the first and second audio signals 230a, 230b to the audio processing circuit 250. The audio processing circuit 250 includes an electronic processor 265 (for example, a microprocessor, an ASIC, or another suitable electronic device) and a memory 270 (for example, a non-transitory, computer-readable storage medium). The electronic processor 265 may retrieve and execute instructions stored on the memory 270 to implement the functionality of the audio processing circuit 250 described herein, including the processing, selecting, and transmitting of audio signals (e.g., the audio signals 230a, 230b). As described below, the audio processing circuit 250 can receive a control signal 252 from the control input interface 255 and output an indication via the indicator 258.

In some examples, the control input interface 255 is a user audio input selector that allows the user to indicate or select an audio signal 230a, 230b to transmit to the host device 275 as an output audio signal 280. The control input interface 255 can include various configurations such as, e.g., a push-button, switch, dial, remote controller, that can receive a user's selection and, in response, provide an indication of the user selection (the control signal 252) to the audio processing circuit 250. In response to the control signal 252, the audio processing circuit 250 may switch or maintain the audio signal 230a or 230b that that audio processing circuit 250 transmits as the output audio signal 280 to the host device 275.

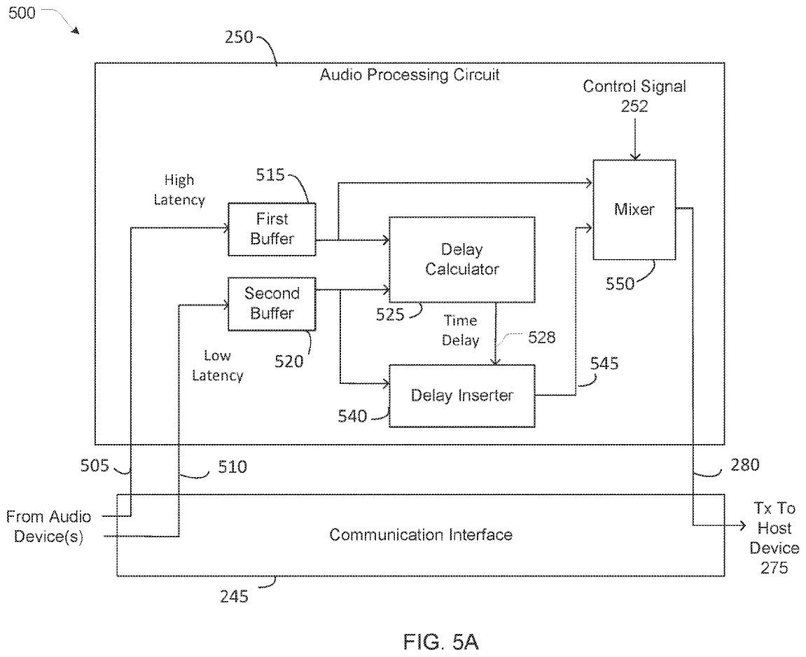

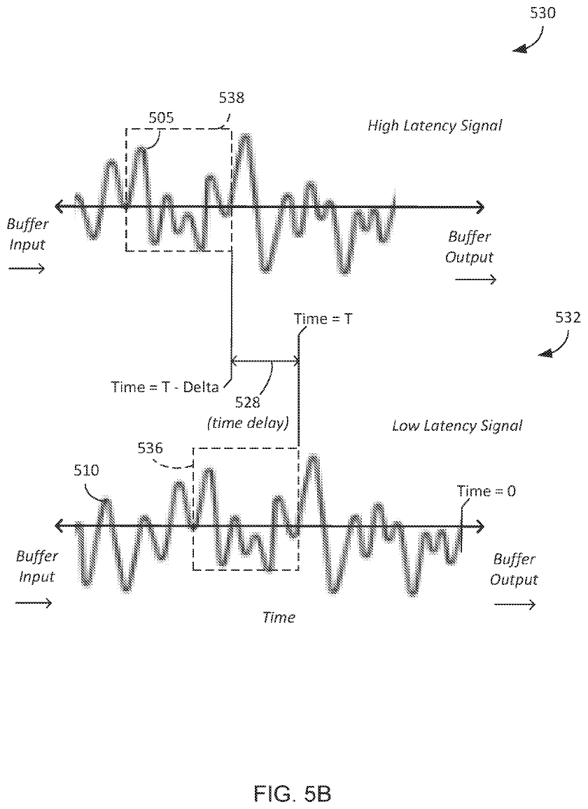

In some examples, the control input interface 255 may generate the control signal 252 as an indication of a selection of the audio signal 230a or 230b in response to detecting insertion of a plug end of a cable (e.g., connected to the audio device 205a or 205b) into an audio jack of a wired interface of the communication interface 245 and in response to detecting removal of a plug end of such a cable from an audio jack of a wired interface of the communication interface 245. Such insertion and removal may be detected by a sensor of the control input interface 255 based on a change in an electrical characteristic (e.g., resistance, capacitance, voltage, current) at a terminal of the audio jack. In some examples, the control input interface 255 may generate the control signal 252 in response to detecting establishment or loss of a wireless communication link via a wireless interface of the communication interface 245 with the audio device 205a or 205b. In some examples, the control input interface 255 may generate the control signal 252 based on a strength of a wireless connection with the audio device 205a, the audio device 205b, or with the host device 275 (e.g., dropping below a strength threshold), or based on a state of charge of a battery of the audio device 205a or 205b (e.g., dropping below a low battery threshold). In some examples, the control signal 252 is generated internally by the electronic processor 265 (e.g., in response to detecting insertion or removal of the plug end of the cable, in response to establishment or loss of a wireless communication link, in response to detecting a strength of a wireless link dropping below a threshold, in response to a state of charge of the battery dropping below the low battery threshold, etc.), and the control signal 252 is received internally by another portion of the electronic processor 265 (e.g., mixer 550 discussed below with respect to FIG. 5A).

In some examples, the audio dock 240 may control the indicator 258 to provide status information of the audio dock 240. For example, the audio processing circuit 250 may control the indicator 258 to indicate the audio device 205a or 205b currently selected, and, thus, the audio signal 230a or 230b being transmitted to the host device 275 as the output audio signal 280. The indicator 258 may include a light indicator (e.g., including one or more light emitting diodes (LEDs) or liquid crystal display (LCD), or the like), audio indicator (e.g., a speaker that beeps, plays an audio recording, or the like), and/or a tactile indicator (e.g., providing a vibration or other tactile output).

Although the system 200 of FIG. 2A is illustrated with two audio devices 205a, 205b, in some examples, the system 200 includes more than two audio devices (e.g., configured similarly to the audio devices 205a or 205b) or fewer than two audio devices (see, e.g., discussion below with respect to FIG. 2B). Although the audio signals 230a, 230b, and 280 may be described above as unidirectional in the direction of the host device 275, in some examples, one or more of the audio signals 230a, 230b, and 280 may be part of respective audio streams that are bidirectional or one or more of the audio signals 230a, 230b, and 280 unidirectional in the other direction away from the host device 275.

FIG. 2B illustrates a system 290 for implementing audio communication with an audio device including both wireless and wired interfaces, according to some examples. With respect to FIGS. 2A and 2B, like components have like reference numbers and the discussion above with respect to FIG. 2A applies similarly to the like components of FIG. 2B, except as otherwise noted. In FIG. 2B, an audio device 292 is similar to the first audio device 205a of FIG. 2A in that the audio device 292 includes the microphone 210 and the speaker 215. The audio device 292 further includes communication circuitry 294. Additionally, like with FIG. 2A, the system 290 of FIG. 2B can be an example of a portion of the system 100 of FIG. 1. For example, the audio device 292 is an example of an audio device of the audio device(s) 110; the audio dock 240 is an example of the audio dock 150, and the host device 275 is an example of the host device 120. Accordingly, the discussion of the components in FIG. 1 is similarly applicable to the corresponding examples of these components in FIG. 2B, unless otherwise noted.

The communication circuitry 294 includes communication interface components. The communication interface components may include a wired interface 296 and a wireless interface 295. The wired interface 296 may include a physical connector or port to which a cable including one or more wires may be coupled. The connector may include an audio jack (e.g., a ¼ inch jack or ⅛ inch jack) or other port (e.g., USB port, Lightning port, or the like) to selectively receive a first plug end of the cable or an end of the cable may be permanently affixed or joined with the connector (e.g., by soldering or otherwise attaching wires of the cable to terminals of the connector). The wireless interface 295 includes a wireless transceiver, which may include an antenna used by digital processing circuitry of the communication circuitry 294 to transmit and receive wireless signals (e.g., with the audio dock 240).

In the system 290, the audio device 292 transmits, via communication circuitry 294, a first audio signal 297 and a second audio signal 298. More particularly, the first audio signal 297 may be a wireless audio signal transmitted by the wireless interface 295 and the second audio signal 298 may be a wired audio signal transmitted by the wired interface 296. Although the audio signals 297 and 298 may be described above as unidirectional in the direction of the host device 275, in some examples, one or more of the audio signals 297 and 298 may be part of respective audio streams that are bidirectional, or one or more of the audio signals 297 and 298 may be unidirectional in the other direction away from the host device 275.

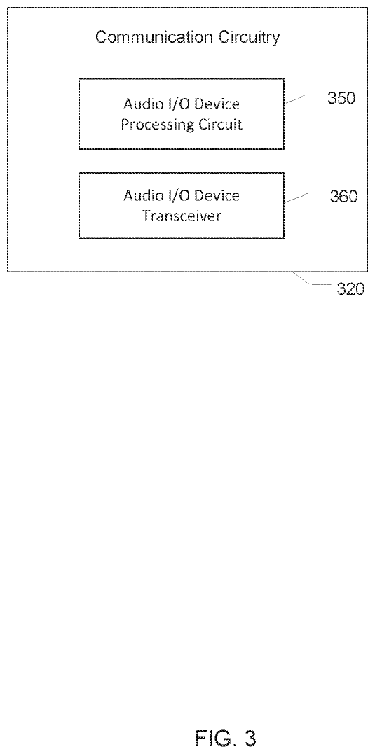

FIG. 3 illustrates communication circuitry 320 that may be included as part of one or more of the audio devices 205a, 205b, and 292 of FIGS. 2A and 2B, in some examples. For example, the communication circuitry 220a, 220b, or 294 may include an audio I/O processing circuit 350 and an audio I/O device transceiver 360. The audio I/O device transceiver 360 can include one or more of a wireless transceiver, a wired transceiver, or both a wired transceiver and a wireless transceiver (e.g., in the case of the audio device 292). The audio I/O processing circuit 350 may include a digital signal processor (e.g., with a memory and processor to execute software stored on the memory) to implement the communication functions of the respective audio device 205a, 205b, or 292 in which the audio I/O processing circuit 350 resides. For example, the digital signal processor, via the audio I/O device transceiver 360, may transmit and receive audio signals to and from the audio dock 240 and may establish wireless and wired communication links. Additionally, the digital signal processor may process audio captured by microphone(s) of the audio device in which the audio I/O processing circuit 350 resides to improve the quality of the audio signal being output to the audio dock, such as by performing filtering, amplification, or other conditioning operations.

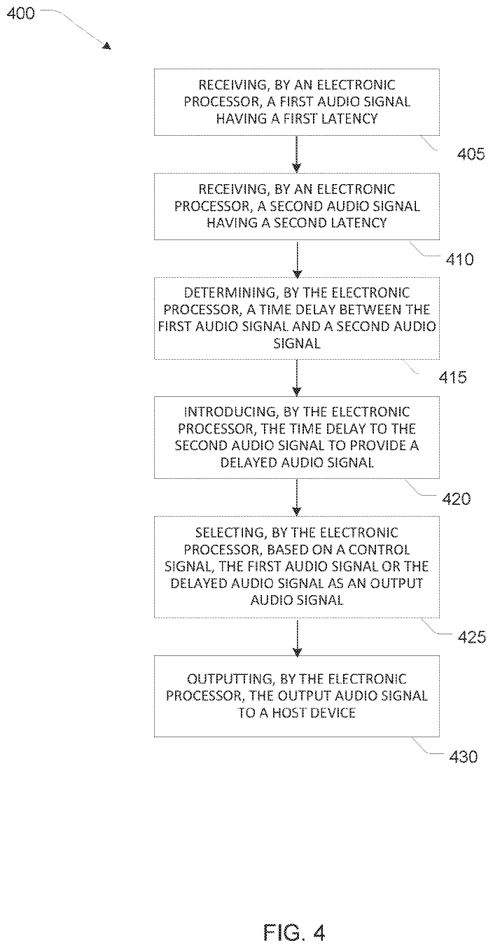

FIG. 4 illustrates a method 400 for implementing seamless audio transition between audio signals, according to some examples. For illustration purposes, the method 400 is described as being performed by an electronic processor 265 of the audio dock 240 of FIG. 2A or 2B and, more particularly, of the audio processing circuit 250 of the audio dock 240. However, the method 400 may be performed by other audio docks, including the audio dock 150 of FIG. 1 (of which the audio dock 240 is an example), and including audio docks with additional, fewer, or different configurations and components. Also for illustration purposes, the method 400 is described with respect to the diagram of FIG. 5A.

As illustrated in FIG. 4, the method 400 includes receiving, by an electronic processor a first audio signal being indicative of captured audio having a first latency (at block 405). For example, the electronic processor 265 may receive the first audio signal 230a from the first audio device 205a via the communication interface 245 (see FIG. 2A). As noted above, the first audio signal 230a may be a wired or wireless audio signal transmitted by the communication circuitry 220a. Alternatively, with reference to FIG. 2B, in some examples, the electronic processor 265 receives the first (wireless) audio signal 297 from the audio device 292 via wireless interface 295 of the communication circuitry 294. With continued reference to FIGS. 2A and 2B, the captured audio may be the audio input 232. In some examples, the first latency may be defined as a time period (or delay) between or corresponding to when the audio input 232 reaches the microphone 210a of the audio device 205a or 292 and when the first audio signal reaches the audio processing circuit 250 (e.g., when received by the electronic processor 265).

In block 410 of the method 400, the electronic processor receives a second audio signal being indicative of captured audio having a second latency that is lower than the first latency (at block 410). For example, with reference to FIG. 2A, the electronic processor 265 may receive the second audio signal 230b from the second audio device 205b. As noted above, the second audio signal 230b may be a wired or wireless audio signal transmitted by the communication circuitry 220b. Alternatively, with reference to FIG. 2B, in some examples, the electronic processor 265 receives the second (wired) audio signal 298 from the audio device 292 via wired interface 296 of the communication circuitry 294. With continued reference to FIGS. 2A and 2B, the captured audio may be the audio input 232. In some examples, the second latency may be defined as a time period (or delay) between or corresponding to when the audio input 232 reaches the microphone 210b of the audio device 205b or the microphone 210a of the audio device 292 and when the second audio signal reaches the audio processing circuit 250 (e.g., when received by the electronic processor 265).

As discussed above with respect to FIGS. 2A and 2B and blocks 405 and 410 of FIG. 4, the first and second audio signals received in blocks 405 and 410 are both audio signals that are indicative of the audio input 232 (the captured audio). Although both audio signals may be indicative of the audio input 232, in some examples, the first and second audio signals may be different in one or more ways. For example, the first audio signal may be a wireless signal and the second audio signal may be a wired signal (or vice versa); the first audio signal may be a digital signal and the second audio signal may be an analog signal (or vice versa); the first audio signal may be transmitted according to a first communication protocol (e.g., Bluetooth, Bluetooth Low Energy (BLE), Wi-Fi, USB 2.0, USB 3.0) and the second audio signal may be transmitted according to a second communication protocol (e.g., another protocol of Bluetooth, Bluetooth Low Energy (BLE), Wi-Fi, USB 2.0, USB 3.0); or a combination of two or more of these differences. Such differences in the transmission medium, encoding, and/or protocol of the audio signals can lead to differences in the respective latencies of the signals. For example, in some examples, an audio signal transmitted via a digital protocol may have a higher latency (e.g., be delayed) relative to an audio signal transmitted via an analog protocol, due in part to digital processing of the audio signal. Similarly, in some examples, an audio signal transmitted via a wireless protocol may have a higher latency relative to an audio signal transmitted via a wired protocol, due in part to additional processing that may be used for the wireless transmission. As discussed above, such differences in the first and second latencies of the first and second audio signals received in blocks 405 and 410, respectively, can lead to a delay, undesired noise (e.g., echo, pop, etc.), or momentary interruption when transitioning between audio signals (e.g., the first and second audio signals 230a and 230b, or 297 and 298) as a source of audio (e.g., for the host device 275)

To assist with the below discussion of the remaining blocks of the method 400, reference is made to FIG. 5A, which illustrates a functional diagram 500 of components of the audio dock 240 (see FIGS. 2A and 2B), according to some examples. For example, FIG. 5A illustrates the communication interface 245 and the audio processing circuit 250 of the audio dock 240. Within the audio processing circuit 250 in FIG. 5A, functional blocks of the audio processing circuit 250 are illustrated. In some examples, each functional block may be implemented by software executed on the electronic processor 265 (e.g., stored and retrieved from the memory 270), hardware components of the processor 265, or a combination thereof. In the example illustrated in FIG. 5A, the audio processing circuit 250 receives a high latency signal 505 and a low latency signal 510 from one or more audio devices via the communication interface 245. For example, the high latency signal 505 may be the first audio signal received by the electronic processor as described with respect to block 405 of FIG. 4 (e.g., the audio signal 230a or 297). Additionally, the low latency signal 510 may be the second audio signal received by the electronic processor as described with respect to block 410 of FIG. 4 (e.g., the audio signal 230b or 298).

In some examples of blocks 405 and 410 of FIG. 4, the receiving of the first and second audio signals by the electronic processor includes, respectively, receiving the first audio signal by a first buffer 515 and receiving the second audio signal by a second buffer 520, as shown in FIG. 5A. The buffers 515 and 520 provide temporary storage of the respective audio signals, for example, to enable processing of the signals as described below. The buffers 515 and 520 may be, for example, first in first out (FIFIO) type buffers.

Returning to FIG. 4, at block 415, the electronic processor determines a time delay between the first audio signal and the second audio signal. For example, the electronic processor 265 may determine the time delay between the first audio signal 230a and the second audio signal 230b (see FIG. 2A), or between the first audio signal 297 and the second audio signal 298 (see FIG. 2B). The electronic processor 265 may determine the time delay between audio signals using a cross-correlation technique to compare the first audio signal and the second audio signal. For example, the electronic processor 265 may use a Fourier transform or convolution as a cross-correlation function to determine the correlation between the first and second audio signals at different time periods. The time delay between two audio signals may be indicated by a peak of the cross-correlation function and the width of the peak indicates the duration of the correlation.

With reference to FIG. 5A, in some examples, this and other cross-correlation techniques may include determining the time delay between the first audio signal (high latency signal 505) and the second audio signal (low latency signal 510) by correlating a first time window (or interval) of the first audio signal of the first buffer 515 to a second time window (or interval) of the second audio signal of the second buffer. The first and second window may be the length of time of the wireless signal that is used in the cross-correlation technique. Once correlated, the time between corresponding points of the first time window and the second time window (e.g., the starting point of the time windows, the ending point of the time windows, the midpoint of the time windows, etc.) may be the time delay between the first and second audio signals. In some examples, other delay determination techniques, such as other cross correlating techniques, are used to determine the time delay between the first and second audio signals. With reference to FIG. 5A, the time delay determination by the electronic processor 265 may be performed at the delay calculator 525. The delay calculator 525 may output the determined time delay as time delay 528.

With reference to FIG. 5B, graphs 530 and 532 illustrate a plot of an example of the low latency signal 510 and of the high latency signal 505, respectively, buffered by the first and second buffers 515 and 520, respectively. For example, the start of buffering of the signals 505, 510 may be considered time 0. Then, at a time T, the high latency signal can be considered at time T−delta (where delta=the time delay 528), while the signal on the low latency signal can be considered at time T. The time windows of the audio signals that are cross-correlated are illustrated as first time window 536 and second time window 538. In some examples, T is greater than the time delay between signals plus the time window length of the audio signals.

Although the first and second audio signals may both represent the captured audio, the signals may have slight variations (e.g., due to noise, microphone characteristics, proximity to source, etc.). Accordingly, in some examples, the first and second audio signals may not be “bit-exact.” However, the first signal and the second signal may include similarities (e.g., amplitude of peaks, distance between peaks) that will help determine a correlation between the signals and, thus, the time delay between the signals. Thus, in some examples, the correlation techniques may seek to correlate multiple time windows of the first and second audio signals. By correlating multiple time windows of the first and second audio signals, the time delay determination (e.g., between a first window of the first audio signal and a second window of the second audio signal) may be validated (e.g., by a correlation or correlations of additional windows of the two audio signals). In some examples, the length of the multiple time windows used for correlation may vary. Additionally, the processor (or delay calculator 525) may determine the correlation in response to correlating a certain number of windows between the signals (e.g., above a window threshold quantity), where each pair of correlated time windows have the same time delay (within a predetermined tolerance). After determining this correlation, the determined time delay that is common across the multiple correlated windows may be used as the time delay determined in block 410.

Returning to block 415 of FIG. 4, in other examples, the electronic processor may determine the time delay by estimating using predetermined time delays based on characteristics of the signals. The predetermined time delays may be stored on a memory (e.g., the memory 270) based on characteristics of the first and second host audio signal (e.g., transmission medium (wire vs. wireless), transmission protocol, signal type (analog vs. digital), or the like). In some examples, a lookup table may map characteristics of the first and second audio signals to predetermined estimated time delays, which may be populated based on testing. Accordingly, the electronic processor 265 may input one or more characteristics of the first and second audio signals to the lookup table, and the predetermined estimated time delay received from the lookup table in response may serve as the time delay that is determined in block 415.

Returning to FIG. 4, in block 420, the electronic processor introduces the time delay to the second audio signal to provide a delayed audio signal. For example, the electronic processor 265 may introduce the time delay to the second audio signal 230b (see FIG. 2A), or to the second audio signal 298 (see FIG. 2B). As noted above, the second audio signal 230b, 298 includes the second latency that is lower than the first latency of the first audio signal 230a, 297. Accordingly, the time delay is introduced to the second audio signal 230b, 298 with a lower latency to align the second audio signal 230b, 298 with the first audio signal 230a, 297. With reference to FIG. 5A, the time delay introduction by the electronic processor 265 may be performed at the delay inserter 540. The delay inserter 540 may receive the time delay 528 and the low latency signal 510. The delay inserter 540 may introduce the time delay 528 into the low latency signal 510 (e.g., with a delay buffer) and output the delayed audio signal as a delayed audio signal 545.

In some examples, the electronic processor 265 is further configured to determine that the second audio signal (e.g., audio signal 230b (FIG. 2A) or audio signal 298 (FIG. 2B)) has the lower latency (relative to the first audio signal). Further, the electronic processor 265 may introduce the time delay to the second audio signal, as described with respect to block 420, in response to this determination. The electronic processor 265 may determine that the second audio signal has the lower latency based on the determined time delay in block 415. For example, when the time delay is a positive number (e.g., as determined using the cross-correlation function), the second audio signal has the lower latency (relative to the first audio signal), and when the time delay is a negative number (e.g., as determined using the cross-correlation function), the second audio signal may have the higher latency (relative to the first audio signal). In some examples, when the electronic processor 265 determines that the first audio signal has the lower latency, the electronic processor 265 may introduce the time delay to the first audio signal in a similar manner as described with respect to block 420. In some examples, over time, the audio signal that has lower latency may change. In such examples, the electronic processor 265 may detect the change and introduce the time delay to whichever audio signal (the first audio signal or the second audio signal) is determined to have the lower latency.

Returning to FIG. 4, in block 425, the electronic processor selects the first audio signal or the delayed audio signal as an output audio signal based on a control signal. For example, the electronic processor 265 selects the first audio signal 230a, 297 or the (delayed) second audio signal 230b, 298 as the output audio signal based on a control signal. In some examples, the control signal may be the control signal 252. In some examples, the control signal 252 may indicate to the electronic processor 265 a particular audio signal (e.g., audio signal 230a or 230b (FIG. 2A) or audio signal 297 or 298 (FIG. 2B)) for selection. In some examples, where one audio signal (e.g., 230a, 230b, 297, or 298) was previously selected (e.g., is a current or active audio signal being provided to the host device 275), the control signal 252 may indicate to the electronic processor 265 to switch (or cycle) to the other (or next) audio signal (e.g., audio signal 230b when audio signal 230a is active, or audio signal 297 when audio signal 298 is active).

As described above with respect to FIG. 2A, in some examples, the control signal 252 may be received by the electronic processor 265 responsive to actuation of the control input interface 255 by a user. In some examples, the control signal 252 may be received by the electronic processor 265 responsive to creation or interruption of a wired connection or link. For example, insertion of the audio plug to an audio jack (e.g., as part of a wired transceiver) of the audio dock 240 may create the wired link with a wired audio device (e.g., the audio device 205a, 205b, or 292) and the removal of the audio plug from the audio jack of the audio dock 240 or loss of power of the wired audio device may interrupt the wired link. In some examples, as described above with respect to FIG. 2A, the control signal 252 may be received by the electronic processor 265 responsive to creation or interruption of a wireless connection or link, responsive to a strength of the wireless link dropping below a strength threshold, or responsive to a state of charge of a battery of the audio device 205a, 205b, or 292 dropping below a low battery threshold. For example, to create a wireless link with the audio dock 240, a wireless audio device (e.g., the audio device 205a, 205b, or 292) can be paired with the audio processing circuit 250 via Bluetooth or Wi-Fi. The wireless link with the wireless audio device may be interrupted when a user disables the wireless audio device (e.g. pressing a power button, removing a wireless earbud from an ear, etc.), when the wireless audio device loses power, when a battery of the wireless audio device has a low state of charge, or by interference or distance between the audio dock 240 and the wireless audio device.

With reference to FIG. 5A, the selection of the first audio signal or the delayed audio signal as an output audio signal based on a control input signal (by the electronic processor from block 425 of FIG. 4) may be performed by the mixer 550, which may also be referred to as a selector or multiplexor. The mixer 550 may receive the control signal 252, the high latency signal 505, and the delayed audio signal 545. In some examples, the control signal 252 serves as a selection indication or selector signal. In response to the control signal 252, the mixer 550 may select the high latency signal 505 or the delayed audio signal 545 for output as the output audio signal 280. In some examples, the control signal 252 may indicate which of the high latency signal 505 or the delayed audio signal 545 to output as the output audio signal 280. For example, the control signal 252 may be a binary signal with a value that indicates one or the other audio signals for selection. In some examples, the control signal 252 may indicate to the mixer 550 to switch from a current audio signal (e.g., the high latency signal 505 or the delayed audio signal 545) currently being provided as the output audio signal 280 to a next audio signal (e.g., the other of the high latency signal 505 and the delayed audio signal 545) to be output as the output audio signal 280.

Returning to FIG. 4, at block 430, the electronic processor outputs the output audio signal to a host device. For example, with reference to FIGS. 2A and 2B, the electronic processor 265 outputs the output audio signal 280 to the host device 275. With reference to FIG. 5A, the outputting of the output audio signal by the electronic processor 265 may be performed by the mixer 550. As illustrated, the output audio signal 280 is output by audio processing circuit 250 via the mixer 550 and to the host device 275 via the communication interface 245 (e.g., via a third transceiver of the transceivers 260 illustrated in FIGS. 2A and 2B).

In some examples, the host device 275 can be connected to a network to transmit the output signal to a far end device that is participating in a teleconference with the host device. For example, with reference to FIG. 1, the host device 275 is connected to the network 125 and the far end device(s) 122. A user of the host device 275 (and audio device(s) 110) may be participating in a teleconference, via the network 125, with other participants using the far end device(s) 122. Accordingly, although the method 400 of FIG. 4 is described with respect to audio signals captured by the audio devices 205a, 205b, and/or 292 and being transmitted to the host device 275 (e.g., for further transmission to the far end device(s) 122), in some examples, (i) the audio signals travel in the opposite direction from the host device 275 to the audio devices 205a, 205b, and/or 292 (e.g., after receipt by the host device 275 of an audio signal from the far end device(s) 122), or (ii) the audio signals are part of a bidirectional audio stream of audio signals transmitting between the audio devices 205a, 205b, and/or 292 and the host device 275 (e.g., as part of a bidirectional teleconference between the host device 275 and the far end device(s) 122).

In either scenario, the audio dock 240 may receive a host audio signal from the host device 275, split or replicate the host audio signal into first and second host audio signals, and output one or both of the first and second host audio signals (via the communication interface 245) to the audio devices 205a and 205b, respectively (see FIG. 2A) or to the communication interfaces 295 and 296, respectively, of the audio device 292 (see FIG. 2B). Additionally, in some of these examples, the audio dock 240 (e.g., the audio processing circuit 250) may determine a time delay between the first and second host audio signals using similar techniques as described above with respect to block 415 (e.g., based on a measured delay determined using cross-correlation or based on an estimation determined using predetermined time delays based on characteristics of the signals). The audio dock may further introduce the time delay to the first or second host audio signal having the lower latency using similar techniques as described with respect to block 420 of FIG. 4. In some examples, the electronic processor 265 may select, based on a control signal (e.g., the control signal 252, as described with respect to block 425), whether to output the first host audio signal or the second host audio signal as a speaker output signal. In some examples, the electronic processor 265 may then output the speaker output signal to the audio device 205a or 205b (FIG. 2A), or to the wireless communication interface 295 or the wireless communication interface 296 of the audio device 292 (FIG. 2B).

In some examples, the process 400 loops so that the time delay is periodically determined to maintain accuracy when introduced into the lower latency signal. For example, while the audio processing circuit 250 is executing the process 400, the first and second audio signals may continue to be received as an on-going stream of input audio data (in block 405 and 410). While the first and second audio signals are being received, the audio processing circuit 250 may periodically determine the time delay between these audio signals (e.g., periodically perform block 415), for example, at a certain or predetermined frequency. The predetermined frequency to determine the time delay between the first and second audio signals (e.g., through the correlation techniques described with respect to block 415) can be once per second, five times per second, ten times per second, or twenty times per second, within a range of once per second to twenty times per second, or another frequency. In some examples, the frequency may be selected based on a particular scenario, such as the types of audio devices, the types of audio signals, or the like. Accordingly, the time delay between the first and second audio signals may be repeatedly determined. The repeated determination of the time delay can ensure that the determined time delay that is introduced to the second audio signal in block 420 (e.g., continuously, as the audio signals continue to be received) is accurate because the actual time delay between the first and second audio signals can change over time. For example, the audio processing circuit 250 may determine a time delay that is a first value in a first determination in block 420, and in a second or later determination in block 420, determine that the time delay has become a greater value (longer delay) or a value (shorter delay).

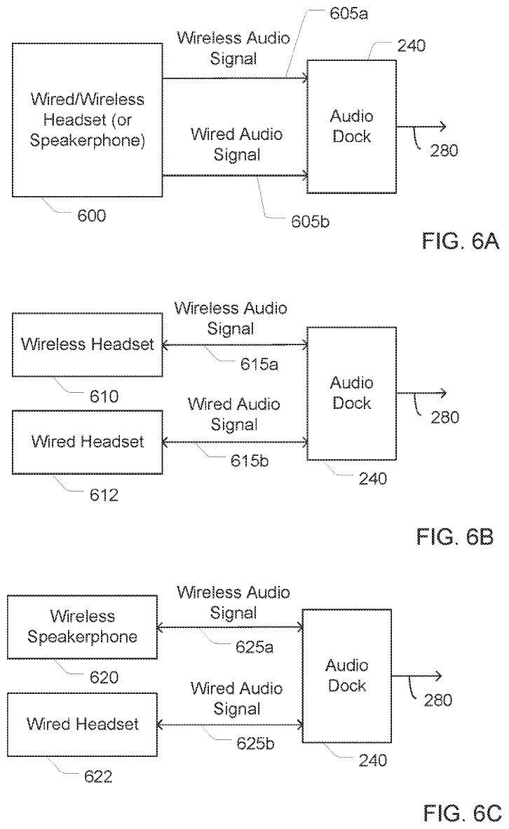

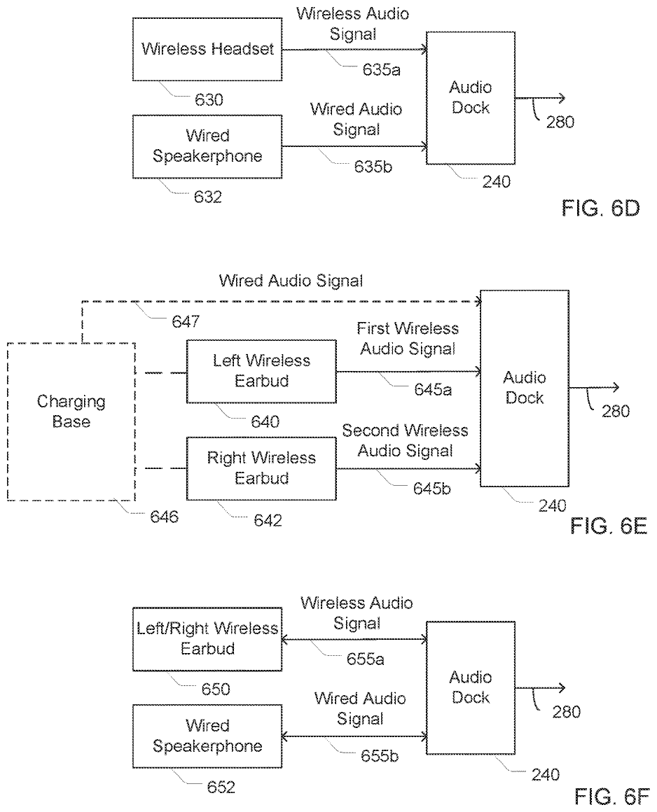

FIGS. 6A-6F illustrate the audio dock 240 in communication with various audio devices and receiving various audio signals. FIG. 6A illustrates the audio dock 240 in communication with a wired/wireless headset 600 that includes both wired and wireless capabilities and that provides the output audio signal 280. The wired/wireless headset 600 is an example of the audio device 292 of FIG. 2B. The audio dock 240 receives a first (wireless) audio signal 605a and a second (wired) audio signal 605b from the wired/wireless headset 605. Using the techniques described herein (e.g., with respect to the method 400 of FIG. 4), the audio dock 240 can seamlessly switch between providing the first (wireless) audio signal 605a as the output audio signal 280 and the second (wired) audio signal 605b as the output audio signal 280. In some examples, the wired/wireless headset 600 is a wired/wireless speakerphone instead of a headset. In some examples, the wired/wireless speakerphone may include a speakerphone housing including a base (e.g., to rest on a desk or other surface) and supporting a speaker, a microphone, and communication circuitry of the speakerphone.

FIG. 6B illustrates the audio dock 240 in communication with a wireless headset 610 and a wired headset 612 and that provides the output audio signal 280. In some examples, the wireless headset 610 is an example of the audio device 205a and the wired headset 612 is an example of the audio device 205b of FIG. 2A. The audio dock 240 receives a first (wireless) audio signal 615a from the wireless headset 610 and a second (wired) audio signal 615b from the wired headset 612. Using the techniques described herein (e.g., with respect to the method 400 of FIG. 4), the audio dock 240 can seamlessly switch between providing the first (wireless) audio signal 615a as the output audio signal 280 and the second (wired) audio signal 615b as the output audio signal 280.

FIG. 6C illustrates the audio dock 240 in communication with a wireless speakerphone 620 and a wired headset 622 and that provides the output audio signal 280. In some examples, the wireless speakerphone 620 is an example of the audio device 205a and the wired headset 622 is an example of the audio device 205b of FIG. 2A. The audio dock 240 receives a first (wireless) audio signal 625a from the wireless speakerphone 620 and a second (wired) audio signal 625b from the wired headset 622. Using the techniques described herein (e.g., with respect to the method 400 of FIG. 4), the audio dock 240 can seamlessly switch between providing the first (wireless) audio signal 625a as the output audio signal 280 and the second (wired) audio signal 625b as the output audio signal 280.

FIG. 6D illustrates the audio dock 240 in communication with a wireless headset 730 and a wired speakerphone 732 and that provides the output audio signal 280. In some examples, the wireless headset 730 is an example of the audio device 205a and the wired speakerphone 632 is an example of the audio device 205b of FIG. 2A. The audio dock 240 receives a first (wireless) audio signal 635a from the wireless headset 730 and a second (wired) audio signal 635b from the wired speakerphone 732. Using the techniques described herein (e.g., with respect to the method 400 of FIG. 4), the audio dock 240 can seamlessly switch between providing the first (wireless) audio signal 635a as the output audio signal 280 and the second (wired) audio signal 635b as the output audio signal 280.

FIG. 6E illustrates the audio dock 240 in communication with a left wireless earbud 640 and a right wireless earbud 642 and that provides the output audio signal 280. In some examples, the left wireless earbud 640 is an example of the audio device 205a and the right wireless earbud 642 is an example of the audio device 205b of FIG. 2A. The audio dock 240 receives a first (wireless) audio signal 645a from the left wireless earbud 640 and a second (wireless) audio signal 645b from the right wireless earbud 642. Using the techniques described herein (e.g., with respect to the method 400 of FIG. 4), the audio dock 240 can seamlessly switch between providing the first (wireless) audio signal 645a as the output audio signal 280 and the second (wireless) audio signal 645b as the output audio signal 280.

In some examples, the audio dock 240 is further in communication with a charging base 646 having an integrated speakerphone via an additional transceiver of the transceivers 260. The charging base 646 may be a charging case or other charger configured to receive and charge the left and right wireless earbuds 640 and 642. The charger base 646 may include a first receptacle for the left wireless earbud 640 and a second receptacle for the right wireless earbud 642. The charger base 646 may receive charging power from the audio dock 240 via a cable coupled to both the charger base 646 and the audio dock 240. The cable may further carry a wired audio signal 647 from the charging base 646 to the audio dock 240. The charging base 646 with integrated speakerphone may be a further example (e.g., another instance of) the audio device 205b of FIG. 2A. Accordingly, the audio dock 240, in some examples of FIG. 6E, is receiving audio signals 645a, 645b, 647 in parallel from three audio devices, respectively, where each of the audio signals 645a, 645b, and 647 is indicative of a captured audio input (e.g., the audio input 232, see FIG. 2A).

Using the techniques described herein (e.g., with respect to the method 400 of FIG. 4), the audio dock 240 in FIG. 6E can seamlessly switch between providing any one of the three audio signals 645a, 645b, or 647 to any other one of the three audio signals 645a, 645b, or 647 as the output audio signal 280. In such examples including three audio signals, the audio dock 240 (for example, via the audio processing circuit 250) may determine respective time delays between the highest latency signal of the three audio signals and each of the other two audio signals, and may introduce the respective time delay to the two lower latency audio signals. As a result, each of the three audio signals may be synchronized with one another, and the audio dock 240 can switch between the audio signals 645a, 645b, and 647 seamlessly. In one example, a control signal (e.g., the control signal 252) may indicate to the electronic processor 265 of the audio dock 240 when a user removes or disables the left wireless earbud 640 (e.g., that is serving as a primary earbud), and the electronic processor 265 may seamlessly switch to outputting the audio signal 645b associated with the right wireless earbud 642 (e.g., that was previously serving as a secondary earbud, but transitions to the primary earbud role). In another example, a control signal (e.g., the control signal 252) may indicate to the electronic processor 265 of the audio dock 240 that a user has selected to activate use of the integrated speakerphone of the charger base 646, and the electronic processor 265 may seamlessly switch to outputting the audio signal 647 associated with the charger base 646. In other examples, the audio dock 240 seamlessly switches between a different two of the three audio signals 645a, 645b, and 647, for example, in response to the control signal 252 indicating a request for such a switch. In other examples, the charging base 646 is not provided and is not in communication with the audio dock 240.

FIG. 6F illustrates the audio dock 240 in communication with a wireless earbud 650 (e.g., either a left or right wireless earbud) and a wired speakerphone 652 and that provides the output audio signal 280. In some examples, the wireless earbud 650 is an example of the audio device 205a and the wired speakerphone 652 is an example of the audio device 205b of FIG. 2A. The audio dock 240 receives a first (wireless) audio signal 655a from the wireless earbud 650 and a second (wired) audio signal 655b from the wired speakerphone 652. Using the techniques described herein (e.g., with respect to the method 400 of FIG. 4), the audio dock 240 can seamlessly switch between providing the first (wireless) audio signal 655a as the output audio signal 280 and the second (wired) audio signal 655b as the output audio signal 280. In some examples, the wired speakerphone 652 is a wireless speakerphone, and the corresponding wired audio signal 655b is instead a wireless audio signal. In such examples, using the techniques described herein (e.g., with respect to the method 400 of FIG. 4), the audio dock 240 can seamlessly switch between providing the first (wireless) audio signal 655a as the output audio signal 280 and the second (wireless) audio signal from the wireless speakerphone as the output audio signal 280.

The configurations of audio devices and audio signals with the audio dock 240 in FIGS. 6A to 6F are merely example configurations. Other configurations of audio devices and audio signals are provided with the audio dock 240 in other examples. Further, as described above, the audio dock 240 is configured to transition between audio signals in these various examples based on various stimulus, which may be indicated by the control signal 252.

In some examples, the audio dock 240 is an in-line dongle. The in-line dongle may include a housing with a user interface that includes the control input interface 255 and/or the indicator 258 (see FIGS. 2A and 2B). In such examples, the one or more audio devices in communication with the audio dock 240 (e.g., the audio devices 205a, 205b, 292) may have respective housings that are separate from the housing of the audio dock 240. In other examples, the audio dock 240 is integrated into the host device 275. For example, the audio dock 240 may have the form of a sound card that is received in a sound card slot of the host device 275. In some examples, the audio dock 240 is integrated with a speakerphone having a microphone, speaker, and communication circuitry. The speakerphone may be, for example, a wireless speakerphone, a wired speakerphone, or a wired/wireless speakerphone. In such examples, the speakerphone components (e.g., microphone, speaker, communication circuitry) may be considered the audio device 205a, 205b, or 292, and a speakerphone housing may support both the audio dock and the audio device 205a, 205b, or 292.

In some examples, aspects of the technology, including computerized implementations of methods according to the technology, can be implemented as a system, method, apparatus, or article of manufacture using standard programming or engineering techniques to produce software, firmware, hardware, or any combination thereof to control a processor device (e.g., a serial or parallel general purpose or specialized processor chip, a single-or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, examples of the technology can be implemented as a set of instructions, tangibly embodied on a non-transitory computer-readable media, such that a processor device can implement the instructions based upon reading the instructions from the computer-readable media. Some examples of the technology can include (or utilize) a control device such as, e.g., an automation device, a special purpose or general-purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.).

Certain operations of methods according to the technology, or of systems executing those methods, can be represented schematically in the figures or otherwise discussed herein. Unless otherwise specified or limited, representation in the figures of particular operations in particular spatial order can not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular examples of the technology. Further, in some examples, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” “block,” and the like are intended to encompass part or all of computer-related systems that include hardware, software, a combination of hardware and software, or software in execution. For example, a component can be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) can reside within a process or thread of execution, can be localized on one computer, can be distributed between two or more computers or other processor devices, or can be included within another component (or system, module, and so on).

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as, e.g., “either,” “one of,” “only one of,” or “exactly one of.” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g., “one or the other but not both”) when preceded by terms of exclusivity, such as, e.g., “either,” “one of,” “only one of,” or “exactly one of.”

Although the present technology has been described by referring to preferred examples, workers skilled in the art will recognize that changes can be made in form and detail without departing from the scope of the discussion.

What is claimed is:

1. A method comprising:
receiving, by an electronic processor, a first audio signal being indicative of captured audio and having a first latency;
receiving, by the electronic processor, a second audio signal being indicative of the captured audio and having a second latency that is lower than the first latency;
determining, by the electronic processor, a time delay between the first audio signal and a second audio signal;
introducing, by the electronic processor, the time delay to the second audio signal to provide a delayed audio signal;
selecting, by the electronic processor, based on a control signal, the first audio signal or the delayed audio signal as an output audio signal; and
outputting, by the electronic processor, the output audio signal to a host device.

2. The method of claim 1 comprising:
wherein the electronic processor receiving the first audio signal comprises receiving the first audio signal wirelessly from a first audio device, and
wherein the electronic processor receiving the second audio signal comprises receiving the second audio signal via a wired connection from the first audio device or from a second audio device.

3. The method of claim 1 comprising:
wherein the electronic processor receiving the first audio signal comprises receiving the first audio signal wirelessly over a first wireless link from a first earbud audio device of a pair of stereo earbuds, and
wherein the electronic processor receiving the second audio signal comprises receiving the second audio signal wirelessly over a second wireless link from a second earbud audio device of the pair of stereo earbuds.

4. The method of claim 1,
wherein the electronic processor receiving the first audio signal comprises receiving the first audio signal into a first buffer,
wherein the electronic processor receiving the second audio signal comprises receiving second first audio signal into a second buffer, and
wherein determining the time delay between the first audio signal and the second audio signal comprises correlating a first time window of the first audio signal of the first buffer to a second time window of the second audio signal of the second buffer and determining a time difference between the first time window and the second time window.

5. The method of claim 1, wherein the control signal that is received by the electronic processor is generated responsive to at least one selected from a group of:
activation of a user audio input selector,
creation of a wired link with a wired audio device that provides the first audio signal,
interruption of the wired link with the wired audio device that provides the first audio signal,
interruption of a wireless link with a wireless audio device that provides the second audio signal, or
creation of the wireless link with the wireless audio device that provides the second audio signal.

6. The method of claim 1, wherein the host device is connected to a network to transmit the output audio signal to a far end host device that is participating in a teleconference with the host device.

7. The method of claim 1, wherein the first audio signal is a digital audio signal and the second audio signal is an analog audio signal.

8. An audio dock comprising:
a communication interface including a first transceiver, a second transceiver, and a third transceiver,
the first transceiver to receive a first audio signal indicative of captured audio and having a first latency,
the second transceiver to receive a second audio signal indicative of the captured audio and having a second latency that is lower than the first latency, and
the third transceiver providing a communication link to a host device; and
an audio processing circuit coupled to the communication interface, the audio processing circuit to:
determine a time delay between the first audio signal and a second audio signal;
introduce the time delay to the second audio signal to provide a delayed audio signal;
select, based on a control signal, the first audio signal or the delayed audio signal as an output audio signal; and
output the output audio signal to the host device via the third transceiver.

9. The audio dock of claim 8,
wherein the first transceiver receives the first audio signal wirelessly over a first wireless link from a first earbud audio device of a pair of stereo earbuds, and
wherein the second transceiver receives the second audio signal wirelessly over a second wireless link from a second earbud audio device of the pair of stereo earbuds.

10. The audio dock of claim 9, wherein the first earbud audio device is a primary earbud that receives the second audio signal via an inter-earbud wireless link with the second earbud audio device and that transmits the second audio signal over a second channel of the first wireless link, and wherein the second earbud audio device is a secondary earbud and the second wireless link is an out-of-band wireless link.

11. The audio dock of claim 9, wherein the communication interface further includes a fourth transceiver to receive a third audio signal indicative of the captured audio and having a third latency, wherein the fourth transceiver receives the third audio signal from an earbud charging case with integrated speakerphone.

12. The audio dock of claim 8, wherein time delay is determined by correlating the first audio signal and a second audio signal.

13. A non-transitory computer-readable medium storing instructions that, when executed, cause a processor to
receive a first audio signal from a first audio device that is indicative of captured audio and having a first latency;
receive a second audio signal from a second audio device that is indicative of the captured audio and having a second latency that is lower than the first latency;
determine a time delay between the first audio signal and a second audio signal;
introduce the time delay to the second audio signal to provide a delayed audio signal;
select based on a control signal, the first audio signal or the delayed audio signal as an output audio signal; and
output the output audio signal to a host device.

14. The non-transitory computer-readable medium of claim 13, wherein the instructions cause the processor to:
receive the first audio signal wirelessly from the first audio device; and
receive the second audio signal via a wired connection from the second audio device.

15. The non-transitory computer-readable medium of claim 13,
wherein receiving the first audio signal comprises receiving the first audio signal into a first buffer,
wherein receiving the second audio signal comprises receiving second first audio signal into a second buffer, and
wherein determining the time delay between the first audio signal and the second audio signal comprises correlating a first time window of the first audio signal of the first buffer to a second time window of the second audio signal of the second buffer and determining a time difference between the first time window and the second time window.

16. The non-transitory computer-readable medium of claim 13, wherein the control signal is generated responsive to activation of a user audio input selector of an audio dock.

17. The non-transitory computer-readable medium of claim 13, wherein the control signal is generated responsive to at least one selected from a group of:
creation of a wired link with a wired audio device that provides the first audio signal,
interruption of the wired link with the wired audio device that provides the first audio signal,
interruption of a wireless link with a wireless audio device that provides the second audio signal, or
creation of the wireless link with the wireless audio device that provides the second audio signal.

18. The non-transitory computer-readable medium of claim 13, wherein the first audio signal is a digital audio signal and the second audio signal is an analog audio signal.
